(19) United States
(12) Patent Application Publication
(10) Pub. No.: US 2002/0121289 A1
(43) Pub. Date: Sep. 5, 2002

(54) Spray bar

(75) Inventors: Brian J. Brown, Palo Alto, CA (US); David G. Andeen, Goleta, CA (US)

Correspondence Address: PATENT COUNSEL, APPLIED MATERIALS, INC., Legal Affairs Department, P.O.BOX 450A, Santa Clara, CA, 95052, US

(73) Assignee: Applied Materials, Inc.

(21) Appl. No.: 10/085,807

(22) Filed: Feb. 27, 2002

Related U.S. Application Data
(60) Provisional application No. 60/273,786, filed on Mar. 5, 2001.

(51) Int. Cl. B08B 7/04

(52) U.S. Cl. 134/6; 134/30; 134/32; 134/902; 134/61; 134/95.2; 134/95.3; 134/42; 134/201; 15/77

(57) ABSTRACT

Methods and apparatus are provided for precisely and repeatably positioning spray bar. In accordance with a first aspect, an apparatus is provided that includes (1) a spray bar having an alignment mark and one or more openings, the spray bar configured to output a fluid spray from the one or more openings; (2) a mounting device having an alignment mark, the mounting device configured to support the spray bar; and (3) a substrate support configured to support a substrate. The alignment mark of the spray bar and the alignment mark of the mounting device may be aligned so as to position a fluid spray output by the spray bar toward a substrate supported by the substrate support. Numerous other methods and apparatus also are provided.

This application claims priority from U.S. provisional application Serial No. 60/273,786 filed Mar. 5, 2001 which is hereby incorporated by reference herein in its entirety.

### FIELD OF THE INVENTION

The present invention relates generally to apparatuses for cleaning thin disks, such as semiconductor substrates, glass substrates (e.g., for use in flat panel displays), compact disks, and the like. More particularly, the present invention relates to a spray bar adapted to supply fluid directly or indirectly to a thin disc.

### BACKGROUND OF THE INVENTION

Within the semiconductor industry, an ever present need exists for improved repeatability in the manufacture of semiconductor devices. Repeatability ensures that semiconductor substrates exposed to similar processes within similar apparatuses exhibit similar characteristics (e.g., similar defect levels, similar film thicknesses, similar feature sizes, etc.) with little substrate-to-substrate variation. Such repeatability should extend not only to substrates processed using a similar process within the same processing apparatus, but also should extend to substrates processed using a similar process within a similar processing apparatus (e.g., such as to substrates using different scrubber devices that perform the same scrubbing process).

FIG. 1 is a side perspective view of a conventional scrubber device 11. The conventional scrubber device 11 may include, for example, a pair of PVA brushes 13, 15, a plurality of rollers 17 adapted to support a substrates S, and a conventional spray bar assembly 18. The conventional spray bar assembly 18 may comprise, for example, a bar 19 having a plurality of nozzles 21 mounted thereto and a mounting device 22 for supporting the bar 19 so that fluid output from the nozzles 21 may be directed to a desired position on the substrate S or on the brushes 13, 15. The conventional scrubber device 11 further comprises a motor 23 coupled to the brushes 13, 15, and to the rollers 17 so as to cause rotation thereof.

Conventionally, when the spray bar 19 is installed within the scrubber device 11, a technician visually positions the spray bar 19 such that the fluid emitted by the nozzles 21 impacts a desired area on the brushes 13, 15 and/or on the substrate S. Specifically, a technician (1) loosens the mounting device 22 (e.g., by loosening a bolt 22a) so that the spray bar 19 may rotate; (2) manually rotates the spray bar 19 to the desired position (e.g., to a position that causes fluid emitted by the nozzles 21 to impact a desired area on the brushes 13, 15 and/or on the substrate S); and then (3) tightens the mounting device 22 (e.g., by tightening the bolt 22a). Due to the imprecise nature of the above positioning process and/or to human error, it is difficult to ensure that the spray bar 19 is precisely positioned when the spray bar 19 is installed (e.g., initially or during a repair or replacement operation) or perturbed (e.g., during a repair or replacement operation for a different portion of the scrubber device 11). Such positional inconsistencies may affect the scrubbing process performed by the scrubber device 11 and may cause scrubber-induced processing variations between substrates processed within the scrubber device 11.

Further, when two or more similar scrubber devices 11 are employed during semiconductor device manufacturing (e.g., during parallel fabrication processes), the imprecise nature of the positioning process for the spray bar 19 of each scrubber device 11 is further exacerbated by the extreme difficultly of ensuring that each spray bar 19 of each scrubber device 11 is identically (or nearly identically) positioned. That is, substrates processed using different scrubber devices may be inadvertently exposed to different processing conditions.

Accordingly, a method and an apparatus are needed that allow a spray bar to be precisely and repeatably positioned.

### SUMMARY OF THE INVENTION

The present invention provides methods and apparatus for precisely and repeatably positioning a spray bar. In accordance with a first aspect of the invention, an apparatus is provided that includes (1) a spray bar having an alignment mark and one or more openings, the spray bar configured to output a fluid spray from the one or more openings; (2) a mounting device having an alignment mark, the mounting device configured to support the spray bar; and (3) a substrate support configured to support a substrate. The alignment mark of the spray bar and the alignment mark of the mounting device may be aligned so as to position a fluid spray output by the spray bar toward a substrate supported by the substrate support.

In accordance with a second aspect of the invention, a scrubber device is provided that includes (1) a spray bar having an alignment mark, the spray bar configured to output a fluid spray; (2) a mounting device having an alignment mark, the mounting device configured to support the spray bar; (3) a substrate support configured to support a substrate; and (4) at least one scrubber brush configured to contact a surface of a substrate supported by the substrate support. The alignment mark of the spray bar and the alignment mark of the mounting device may be aligned so as to position a fluid spray output by the spray bar toward the at least one scrubber brush.

In accordance with a third aspect of the invention, an apparatus configured to rinse and dry a substrate is provided. The apparatus includes (1) a tank of cleaning fluid configured to at least partially submerge a substrate; (2) a lifting mechanism configured to lift a substrate from the cleaning fluid; and (3) a drying vapor source positioned to supply drying vapors to an air/substrate/cleaning fluid interface formed when the lifting mechanism lifts a substrate from the cleaning fluid. The drying vapor source includes (1) a spray bar having an alignment mark and one or more openings, the spray bar configured to output a drying vapor from the one or more openings; and (2) a mounting device having an alignment mark, the mounting device configured to support the spray bar. The alignment mark of the spray bar and the alignment mark of the mounting device may be aligned so as to position a drying vapor output by the spray bar toward the air/substrate/cleaning fluid interface.

In accordance with a fourth aspect of the invention, an apparatus configured to rinse and dry a substrate is provided. The apparatus includes (1) a tank of cleaning fluid configured to at least partially submerge a substrate; (2) a lifting mechanism configured to lift a substrate from the cleaning fluid; (3) a rinsing fluid source positioned to supply rinsing fluid to a surface of a substrate as the lifting mechanism lifts the substrate from the cleaning fluid, wherein the rinsing fluid contacts the substrate thereby forming an air/substrate/rinsing fluid interface; and (4) a drying vapor source positioned to supply drying vapors to the air/substrate/rinsing fluid interface. The drying vapor source includes (1) a spray bar having an alignment mark and one or more openings, the spray bar configured to output a drying vapor from the one or more openings; and (2) a mounting device having an alignment mark, the mounting device adapted to support the spray bar. The alignment mark of the spray bar and the alignment mark of the mounting device may be aligned so as to position a drying vapor output by the spray bar toward the air/substrate/rinsing fluid interface. Numerous other apparatuses and methods are also provided.

Other features and aspects of the present invention will become more fully apparent from the following detailed description of the preferred embodiments, the appended claims and the accompanying drawings.

### BRIEF DESCRIPTION OF THE DRAWINGS

FIG. 1 is a side perspective view of a conventional scrubber device as previously described;

FIG. 2 is a side perspective view of a first inventive spray bar assembly that comprises a spray bar having an alignment mark and a mounting device having an alignment mark;

FIG. 3A is a side perspective view of a second inventive spray bar assembly that comprises a mounting device having a plurality of alignment marks;

FIG. 3B is a side perspective view of a third inventive spray bar assembly that comprises a spray bar having a plurality of alignment marks;

FIG. 3C is a side perspective view of a fourth inventive spray bar assembly that comprises a spray bar and a mounting device both having a plurality of alignment marks;

FIG. 3D is a top plan view of an exemplary spray bar configured in accordance with the present invention;

FIG. 3E is a front plan view of an exemplary mounting device configured in accordance with the present invention;

FIG. 4 is a side perspective view of a scrubber device that employs the inventive spray bar assembly of FIG. 2;

FIG. 5 is a side perspective view of a scrubber device that employs the inventive spray bar assembly of FIG. 3A;

FIGS. 6A and 6B are a side elevational view and a front elevational view, respectively, of an exemplary cleaning/drying system configured in accordance with the present invention;

FIG. 6C is an enlarged side elevational view of the substrate S of FIGS. 6A and 6B; and

FIGS. 7A-7D are sequential side elevational views of the exemplary cleaning/drying system of FIGS. 6A and 6B useful in describing the operation of the cleaning/drying system.

### DETAILED DESCRIPTION

In accordance with at least one aspect of the invention, a novel spray bar assembly is provided that employs alignment marks to ensure precise and repeatable application of a fluid during a semiconductor device manufacturing process. For example, the inventive spray bar assembly may comprise a spray bar having an alignment mark and one or more openings, the spray bar adapted to output a fluid spray from the one or more openings (e.g., a plurality of nozzles). The spray bar assembly also may include a mounting device having an alignment mark, the mounting device adapted to support the spray bar. The alignment mark of the spray bar and the alignment mark of the mounting device may be positioned such that when the mounting device is properly mounted within a chamber and the spray bar alignment mark and the mounting device alignment mark are aligned, the one or more openings of the spray bar may direct fluid to a desired location (e.g., to a substrate, to a scrubber brush, to an air/substrate interface, to an air/substrate/cleaning fluid interface, to an air/substrate/rinsing fluid interface, etc.). In a further aspect, the spray bar and/or the mounting device may comprise a plurality of alignment marks to enable an operator to select one of a plurality of precise locations to direct the fluid.

As used herein, a “fluid” may include any liquid or gas. A cleaning fluid may be water, ElectraClean solutions™ marketed by Applied Materials, Inc., a combination thereof or any other fluid or fluids suitable for cleaning a substrate. A rinsing fluid may be water or any other fluid or fluids suitable for rinsing a substrate. A drying vapor may include isopropyl alcohol (IPA) or any other vapor, vapors, fluid or fluids suitable for drying a substrate.

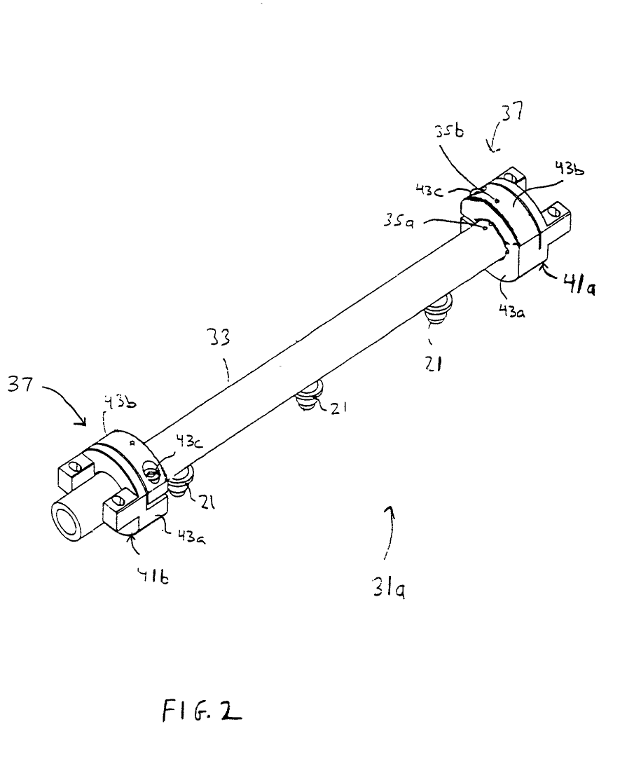

FIG. 2 is a side perspective view of a first inventive spray bar assembly 31a that may comprise a spray bar 33 (having an alignment mark 35a) and mounting devices 37 (one or both having an alignment mark 35b). In one aspect, the alignment marks 35a, 35b may comprise a pair of holes as shown in FIG. 2, although the alignment marks 35a, 35b may comprise other forms such as notches, etc. The spray bar 33 may have an alignment mark on both ends if desired.

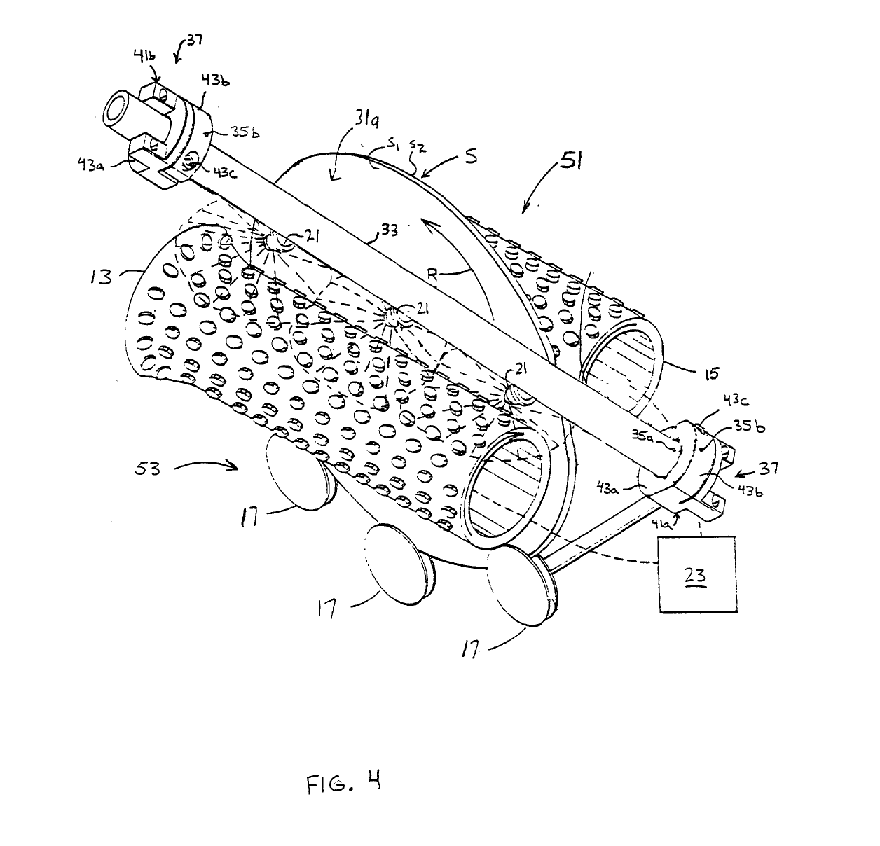

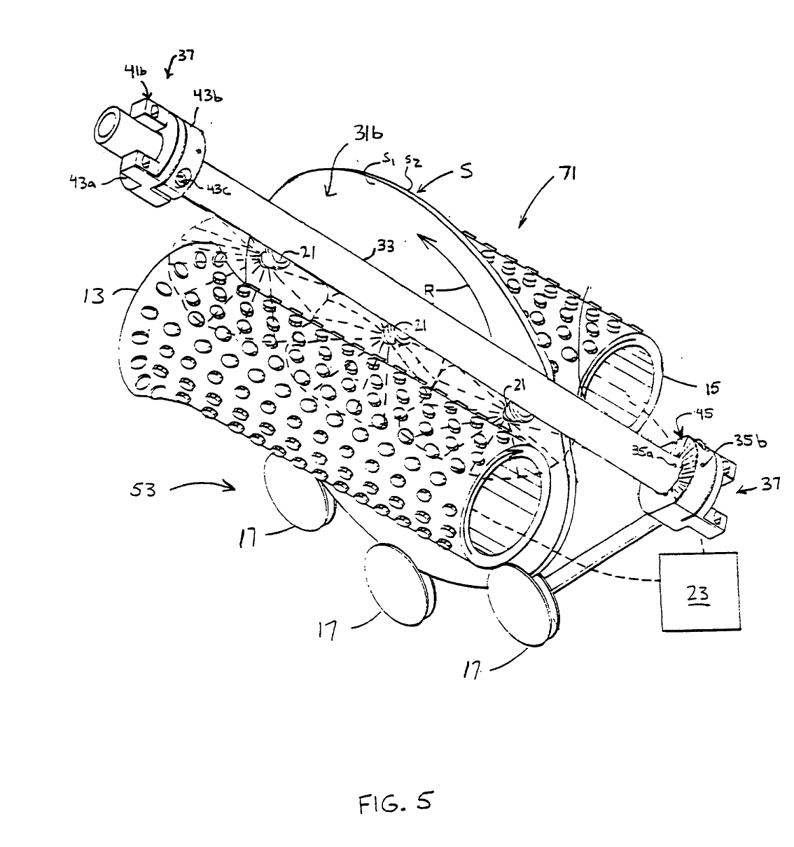

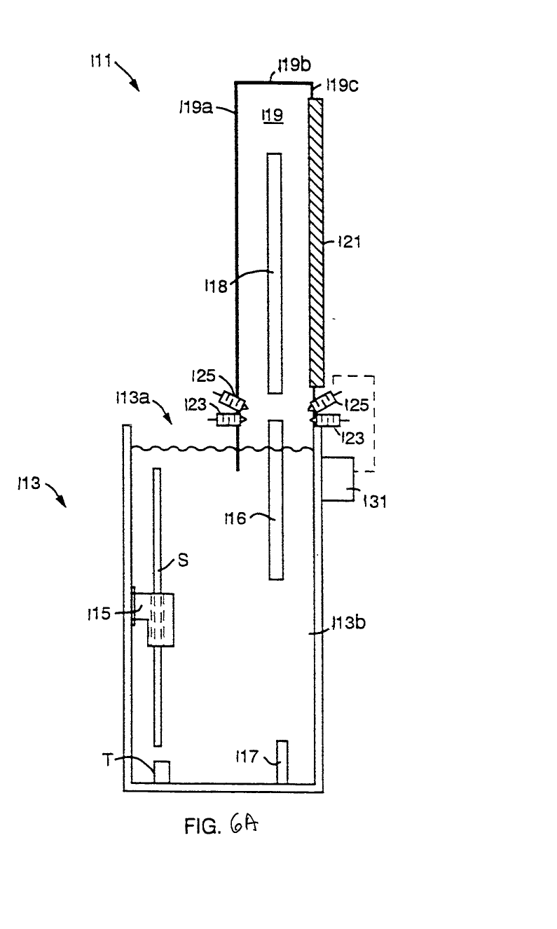

The spray bar 33 may comprise one or more openings (e.g., one or more nozzles 21 mounted thereto or some other known openings). The nozzles 21 are adapted to spray a jet of fluid toward a location that depends on the position of the spray bar 33 relative to the mounting devices 37. The fluid may be supplied to the spray bar assembly 31a via a fluid source (not shown) as described below with reference to FIGS. 4-5. While three nozzles 21 are shown in FIG. 2, it will be understood that any number of nozzles 21 and/or other openings may be employed. Any nozzles may be employed for the nozzles 21. One suitable nozzle is the HH-KY KYNAR® FullJet spray nozzle marketed by Spraying Systems Co.

In a first aspect of the invention, the mounting devices 37 comprise a pair of mounting clamps 41a, 41b adapted to support the spray bar 33 therebetween. Each clamp 41a, 41b includes a base portion 43a, a clamping portion 43b and a bolt 43c that may be tightened so as to draw the base portion 43a and the clamping portion 43b together (e.g., so that the spray bar 33 is rigidly held therebetween and is prevented from rotating). Note that to prevent the spray bar 33 from rotating, only one mounting clamp 41a, 41b need be employed. In general, any number of mounting clamps may be used to support the spray bar 33 (e.g., one, two, three, etc.), other forms of mounting devices may be used to support the spray bar 33 and/or a combination of mounting clamps and other forms of mounting devices may be used to support the spray bar 33. The mounting devices 37 may be secured to a chamber surface (not shown) or some other structure (e.g., depending on where the inventive spray bar assembly is to be employed) by any known mechanism. As described further below with reference to FIGS. 4-7D, when the alignment mark 35a on the spray bar 33 is positioned adjacent to or “aligned with” the alignment mark 35b on the mounting device 37, the nozzles 21 may precisely direct fluid spray toward a desired location (e.g., toward a substrate, toward a scrubber brush, toward an air/substrate/rinsing fluid interface, etc.).

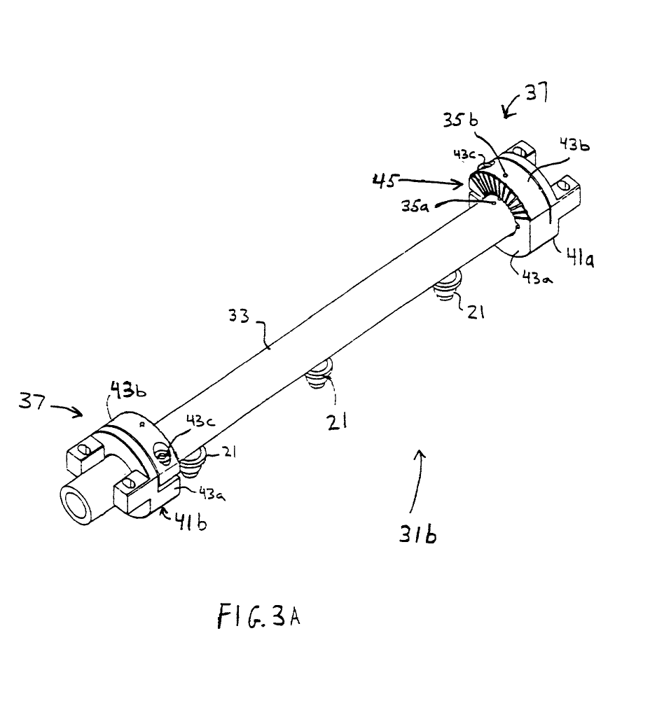

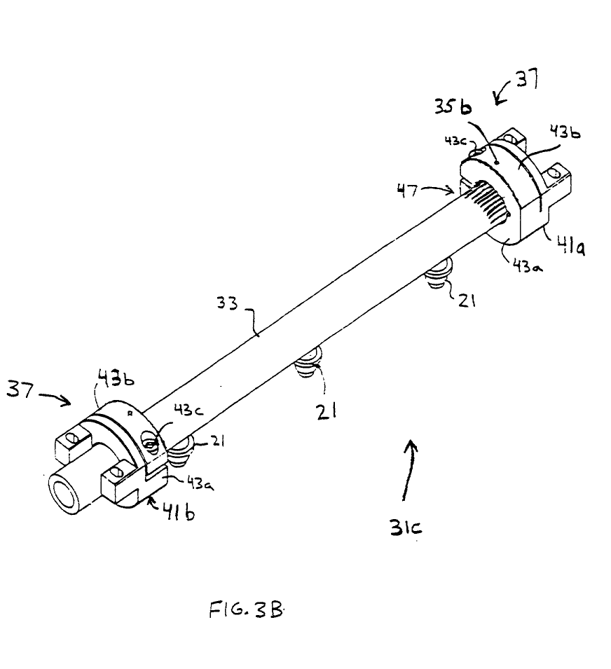

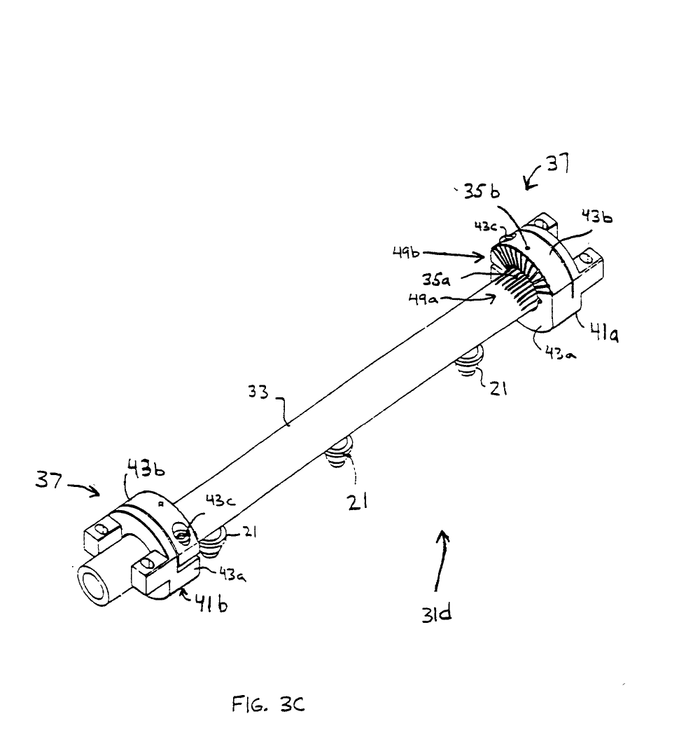

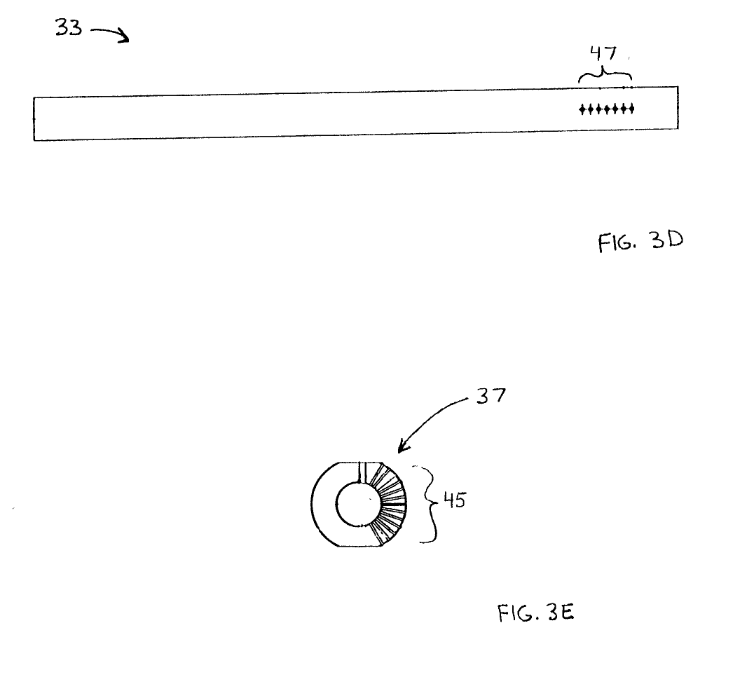

FIG. 3A is a side perspective view of a second inventive spray bar assembly 31b that comprises a mounting device 37 having a plurality of alignment marks 45. One or both of the mounting devices 37 may be so configured. The inventive spray bar assembly 31b, for example, may comprise the same components as the inventive spray bar assembly 31a of FIG. 2 (as shown), or may comprise other components as previously described (e.g., fewer, more or different mounting devices, nozzles, etc.). In the embodiment of FIG. 3A, the additional alignment marks 45 on the mounting device 37 comprise a plurality of notches as shown, although the alignment marks 45 may comprise holes or any other surface indicia. The alignment marks 45 may be regularly or irregularly spaced. In one embodiment, the alignment marks 45 are spaced by 10 degrees relative to the center of the

FIG. 3B is a side perspective view of a third inventive spray bar assembly 31c that comprises a spray bar 33 having a plurality of alignment marks 47. One or both ends of the spray bar 33 may be so configured. The inventive spray bar assembly 31c, for example, may comprise the same components as the inventive spray bar assembly 31a of FIG. 2 (as shown), or may comprise other components as previously described (e.g., fewer, more or different mounting devices, nozzles, etc.). In the embodiment of FIG. 3B, the additional alignment marks 47 on the spray bar 33 comprise a plurality of notches as shown, although the alignment marks may comprise other forms such as holes or other surface indicia. The alignment marks 47 may be regularly or irregularly spaced. In one embodiment, the alignment marks 47 are spaced by 10 degrees relative to the center of the spray bar 33 (as shown), although other spacings may be employed.

FIG. 3C is a side perspective view of a fourth inventive spray bar assembly 31d that comprises a spray bar 33 and a mounting device 37 both having a plurality of alignment marks 49a, 49b, respectively. One or both ends of the spray bar 33 and/or one or both of the mounting devices 37 may be so configured. The inventive spray bar assembly 31d, for example, may comprise the same components as the inventive spray bar assembly 31a of FIG. 2 (as shown), or may comprise other components as previously described (e.g., fewer, more or different mounting devices, nozzles, etc.). In the embodiment of FIG. 3C, the additional alignment marks 49a on the spray bar 33 and the additional alignment marks 49d on the mounting device 37 comprise a plurality of notches as shown, although alignment marks 49a, 49b may comprise holes or any other surface indicia. The alignment marks 49a and/or 49b may be regularly or irregularly spaced. In one embodiment the alignment marks 49a and/or 49b are spaced by 10 degrees relative to a center of the spray bar 33 and/or the mounting device 37 (as shown), although other spacings may be employed. More than one type of alignment mark may be used by the spray bar 33 and/or by the mounting device 37. For example, the spray bar 33 of FIG. 3C comprises both the alignment mark 35a and the alignment marks 49a, and the mounting device 37 comprises both the alignment mark 35b and the alignment marks 49b. Any other combination and/or or any other number of alignment marks may be similarly employed.

FIG. 3D is a top plan view of an exemplary spray bar 33 configured in accordance with the present invention. The spray bar 33 of FIG. 3D comprises press fit black PVC having a plurality of alignment marks 47. The alignment marks 47 comprise seven, 0.08 inch diameter, 0.08 inch deep holes spaced by 0.16 inches. As stated, any other number or type of alignment marks may be similarly employed, and the spray bar 33 may be fabricated from any suitable material.

FIG. 3E is a front plan view of an exemplary mounting device 37 configured in accordance with the present invention. The mounting device 37 of FIG. 3E comprises press fit black PVC having a plurality of alignment marks 45. The alignment marks 45 comprise thirteen 0.040 inch wide, 0.04 inch deep grooves spaced by 10° from a center of the mounting device 37. As stated, any other number or type of alignment marks may be similarly employed, and the mounting device 37 may be fabricated from any suitable material.

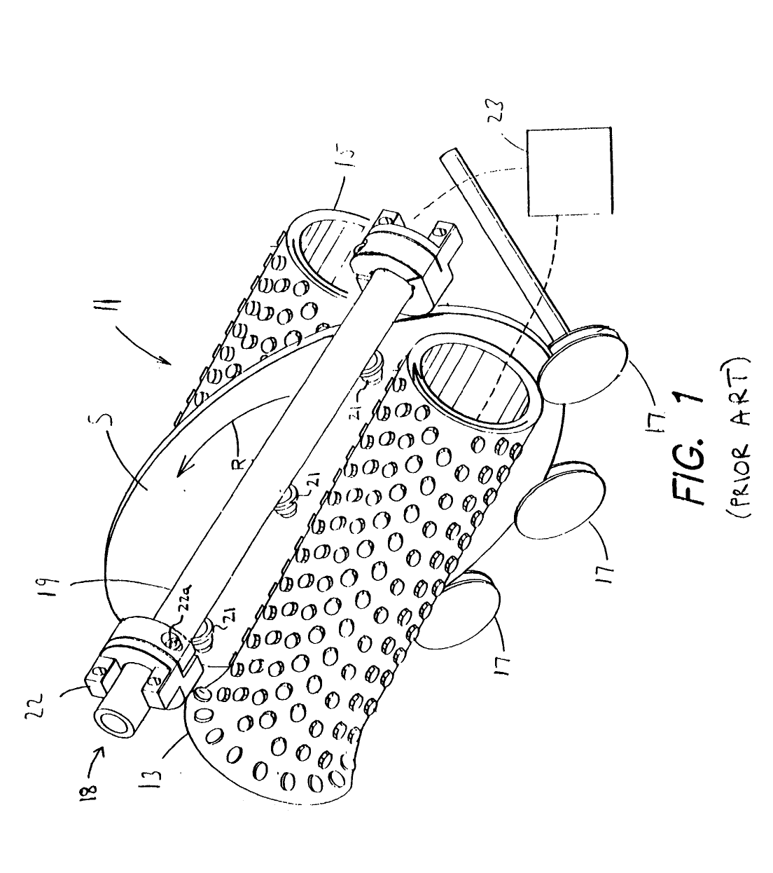

FIG. 4 is a side perspective view of a scrubber device 51 that employs the inventive spray bar assembly 31a of FIG. 2. The scrubber device 51 may comprise the same components as the conventional scrubber device 11 of FIG. 1, with the addition of the inventive spray bar assembly 31a. In the embodiment of FIG. 4, the scrubber device 51 comprises a platform 53 (e.g., comprising the rollers 17) adapted to support a substrate S to be cleaned, and further comprises a pair of PVA brushes 13, 15 configured to contact both the major surfaces S₁ and S₂ of the substrate S, respectively. Note that the spray bar assembly 31a, the platform 53 (e.g., the rollers 17), the brushes 13, 15, etc., may be supported by a chamber (not shown) that encloses these items via any known support mechanism or mechanisms (not shown).

The scrubber device 51 also includes a source of fluid (not shown) coupled to the spray bar 33 and adapted to supply a fluid thereto. As stated previously, the fluid may be water (e.g., de-ionized water) or any other suitable fluid. The fluid is delivered to the spray bar 33 with a suitable pressure. Factors which affect the pressure with which fluid is delivered to the spray bar 33 include the type of fluid used, the application in which the spray bar 33 is being employed (e.g., within a scrubber device, within a Marangoni dryer, etc.), or the like.

As further shown in FIG. 4, the nozzles 21 of the inventive spray bar assembly 31a are adapted to spray fluid toward a desired location (e.g., toward the PVA brush 13 and/or toward the S₁ surface of the substrate S). Typically a second inventive spray bar assembly (not shown) is located on the S₂ side of the substrate S (e.g., for directing a fluid spray toward the PVA brush 15 and/or toward the S₂ surface of the substrate S). In one aspect, the nozzles 21 are positioned to spray fluid toward the center and toward the edges of the substrate S as shown.

A conventional spinning mechanism such as a motor, represented generally by reference number 23, is coupled to the PVA brushes 13, 15 so as to selectively spin the PVA brushes 13, 15 as described below. Further, a rotating mechanism is coupled to the rollers 17 so as to rotate the substrate S positioned thereon.

When the spray bar assembly 31a is installed within the scrubber device 51, a technician (1) loosens each mounting device 37 (e.g., by loosening the bolt 43c of each mounting clamp 41a, 41b); (2) rotates the spray bar 33 to align the alignment mark 35a of the spray bar 33 with the alignment mark 35b of one or both of the mounting devices 37 (e.g., the mounting clamp 41a and/or the mounting clamp 41b); and then (3) tightens each mounting device 37 (e.g., by tightening the bolt 43c). As used herein, “aligned” means “positioned based on” and does not require that the marks/surface indicia be physically proximate (e.g., as long as the marks of the spray bar and mounting device may be repeatably positioned relative to one another). The other spray bar assemblies described herein may be similarly installed and/or adjusted.

By thus aligning the alignment mark 35a of the spray bar 33 with the alignment mark 35b of one or both of the mounting devices 37, a user is ensured that the fluid spray output from the nozzles 21 will strike the desired location (e.g., the substrate S and/or the scrubber brush 13 or 15). That is, because of the alignment marks 35a, 35b (or the alignment marks 45, 47 previously described with reference to FIGS. 3A-3E), a user is ensured that the spray bar 33 is precisely positioned when the spray bar 33 is installed (e.g., initially or during a repair or replacement operation) or perturbed (e.g., during a repair or replacement operation for a different portion of the scrubber device 51). In this manner, positional inconsistencies due to spray bar positioning which would otherwise affect the scrubbing process performed by the scrubber device 51 are reduced as are scrubber-induced processing variations between substrates processed within the scrubber device 51.

Further, when two or more similar scrubber devices 51 are employed during semiconductor device manufacturing (e.g., during parallel fabrication processes), the alignment marks 35a, 35b (or the alignment marks 45, 47 previously described with reference to FIGS. 3A through 3E) of the inventive spray bar assembly ensure that each spray bar of each scrubber device is identically (or nearly identically) positioned. That is, substrates processed using different scrubber devices may be exposed to nearly identical processing conditions in contrast to prior art scrubber devices.

The spray bars 33 of the spray bar assemblies 31b-31d of FIGS. 3A-3C, respectively, may be similarly installed and/or positioned with similar precision and repeatability. However, the numerous alignment marks provided by the spray bars 33 and/or by the mounting devices 37 of the spray bar assemblies 31b-31d allow a user to select any of a number of desired locations for the fluid spray output from a spray bar to impact.

Referring again to FIG. 4, once the spray bar 33 has been positioned (as described above), The first and second brushes 13, 15 are placed in an open position (not shown), a sufficient distance from each other so as to allow a substrate S to be inserted therebetween. Mechanisms (not shown) for moving the brushes 13, 15 between the open position (not shown) and a closed position (described below) are well known in the art and are therefore not further described herein. Thereafter, the substrate S to be cleaned is positioned between the PVA brushes 13, 15 and the brushes 13, 15 assume a closed position (FIG. 4), sufficiently close to each other so that the brushes 13, 15 hold the substrate S in place therebetween and so that the brushes 13, 15 exert a force on the substrate surfaces S₁ and S₂ sufficient to achieve effective cleaning.

Once the brushes 13, 15 are in the closed position, the spinning mechanism 23 is engaged and the first and second brushes 13, 15 begin to spin. In one aspect, the brushes 13, 15 spin in opposite directions, applying forces to the substrate S in a first direction (e.g., downward) while the substrate S rotates either clockwise or counterclockwise (e.g., via rotation of the rollers 17). This drives the substrate S into the rollers 17, so that the substrate S remains captured thereby.

The first and second brushes 13, 15 contact the major surfaces S₁ and S₂ of the substrate S, cleaning slurry residue and/or other particulates/contaminants therefrom. While the first and second brushes 13, 15 scrub the major surfaces S₁ and S₂ of the substrate S, the nozzle 21 sprays fluid on the brushes 13, 15 and/or on the major surfaces S₁ and S₂ of the substrate S. The liquid aids the scrubbing process by washing slurry residue and/or other particulates/contaminants from brush and/or substrate surfaces.

Once the substrate S has been scrubbed clean, the brushes 13, 15 are opened (not shown), and the substrate S is removed. Another substrate then may be cleaned via the inventive scrubber device 51.

FIG. 5 is a side perspective view of a scrubber device 71 that employs the inventive spray bar assembly 31b of FIG. 3A. The scrubber device 71 may comprise the same components as the scrubber device 51 of FIG. 4, with the inventive spray bar assembly 31a being replaced by the inventive spray bar assembly 31b. An additional spray bar assembly (not shown) may be employed to deliver fluid to the brush 15 and/or to the substrate surface S_{2.} The operation of the scrubber device 71 is similar to the operation of the scrubber device 51 of FIG. 4 and is not described in detail herein.

In the embodiment of FIG. 5, the use of the plurality of alignment marks 45 on the mounting device 37 allows a user to precisely select one of a plurality of locations to direct a fluid spray output from the nozzles 21 (e.g., on the scrubber brush 13, on the substrate surface S_{1,} on an upper portion of the substrate surface S_{1,} on both the scrubber brush 13 and the substrate surface S_{1,} etc.). Thus, when two or more equivalent scrubber devices 71 are employed, the alignment marks 45 may ensure that the position of the nozzles 21 relative to the mounting device 37 is identical (or nearly identical) in each scrubber device 71 so as to ensure precise and repeatable application of fluid. The spray bar assemblies 31c and 31d may be similarly employed within a scrubber device to affect precise and repeatable fluid application.

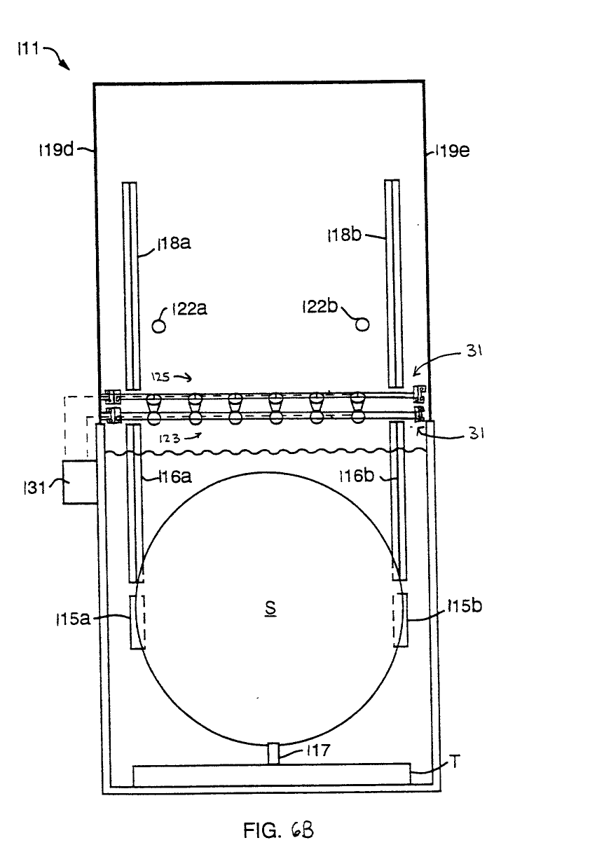

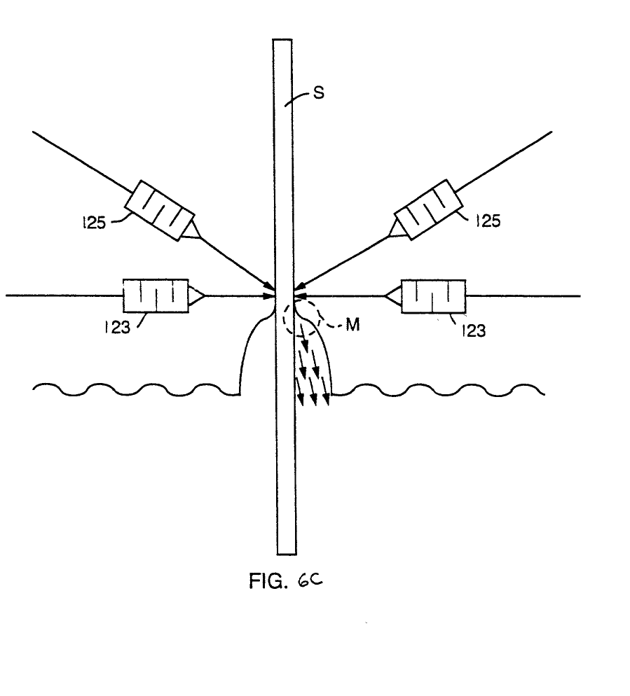

FIGS. 6A and 6B are a side elevational view and a front elevational view, respectively, of an exemplary cleaning/drying system 111 configured in accordance with the present invention. The cleaning/drying system 111 comprises a tank 113 of cleaning fluid. The tank 113 comprises two portions, a substrate receiving and cleaning portion 113a and a substrate rinsing portion 113b. A substrate shuttle 115 is coupled to carry a substrate S from the substrate receiving and cleaning portion 113a to the substrate rinsing portion 113b. The substrate shuttle 115 may be designed to support the substrate S vertically along the lateral sides thereof as shown in FIG. 6B. Thus, a lifting mechanism 117 within the substrate rinsing portion 113b of the tank 113 can extend upward between a first and a second supporting sides 115a, 115b of the substrate shuttle 115, lifting the substrate S therebetween.

A first pair of rails 116a, 116b are mounted within the rinsing portion 113b and are positioned to receive the substrate S as the lifting mechanism 117 lifts the substrate S from the first and the second supporting sides 115a, 115b of the substrate support 115. A second pair of rails 118a, 118b are mounted within a drying enclosure 119 and are positioned to receive the substrate S from the first pair of rails 116a, 116b.

The drying enclosure 119 is positioned above the substrate rinsing portion 113b of the tank 113 such that a substrate can be lifted from the substrate rinsing portion 13b into the drying enclosure 119. The drying enclosure 119 is formed by a plurality of walls 119a-e. The outer sidewall 119c has a sealable port 121 through which the substrate S may be extracted. The inner wall 119a of the drying enclosure 119 extends downward so as to be partially submerged in the fluid contained within the tank 113. The drying enclosure 119 is either integral with the tank 113, or is sealingly coupled thereto via the outer sidewall 119c. The walls 119a-e may contain a plurality of holes (not shown) for exhausting residual vapors into an exhaust system (not shown).

Within the drying enclosure 119, a rinsing fluid supply comprising one or more rinsing fluid nozzles 123 is positioned to spray rinsing fluid across the entire horizontal diameter of the substrate S as the substrate S is lifted from the substrate rinsing portion 113b, and a drying vapor supply comprising one or more drying vapor nozzles 125 is positioned to flow drying vapor across the entire horizontal diameter of the substrate S as the substrate S is lifted from the substrate rinsing portion 113b. The drying vapor nozzles 125 preferably are positioned so that the drying vapor will be absorbed by the rinsing fluid at an air/substrate/rinsing fluid interface 127 shown in FIG. 6C. To achieve such absorption, the drying vapor flow preferably strikes the substrate S 1-5 mm above the air/substrate/rinsing fluid interface 127. Also, as shown in FIG. 6C, the air/substrate/rinsing fluid interface 127 preferably forms a meniscus (as enclosed by the dashed circle “M”) which facilitates Marangoni drying.

As best seen with reference to FIG. 6B, the rinsing fluid nozzles 123 and/or the drying vapor nozzles 125 may be mounted to one or more of the inventive spray bar assemblies 31a-31d (represented generally by reference numeral 31 in FIG. 6B). In this manner, rinsing fluid and/or dry vapor may be precisely and repeatably directed toward an air/substrate interface and/or an air/substrate/rinsing fluid interface of a substrate (e.g., through use of the alignment marks 35a, 35b, 45 and/or 47 as previously described). Accordingly, substrates dried within the same or different cleaning/drying systems will be exposed to similar processing conditions through use of the inventive spray bar assemblies. It will be understood that one or both of rinsing fluid and drying vapor may be delivered by the inventive spray bar assemblies, and that different spray bar assemblies may be used to deliver rinsing fluid and drying vapor.

Within the drying enclosure 119, the second pair of rails 118a, 118b is positioned to contact a dry portion (i.e., a portion that has passed through the rinsing fluid and drying vapor sprays) of the substrate S and to thereby receive the substrate S from the lifting mechanism 117. Retractable positioning pins 122a, 122b engage the substrates in the uppermost position, and hold the substrate S in a fixed position so that a wafer handler (not shown) may repeatably remove the substrate S from the drying enclosure 119.

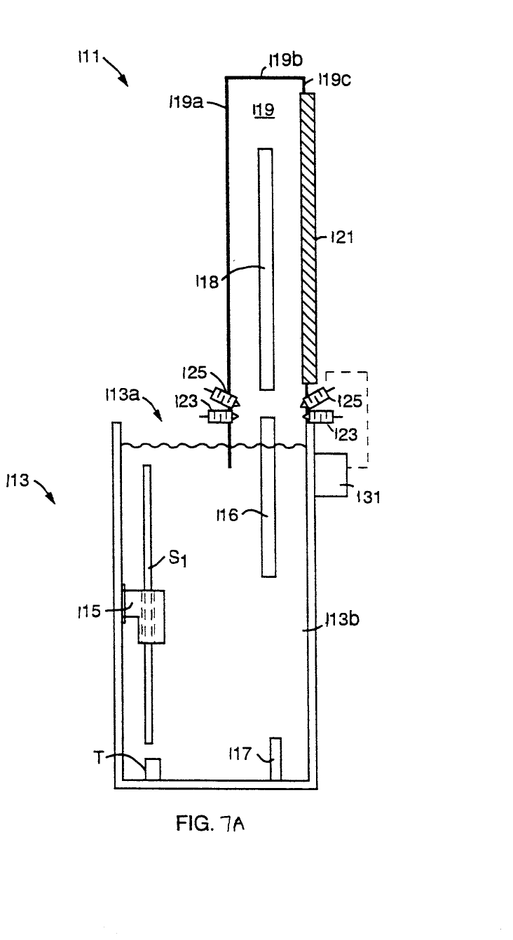

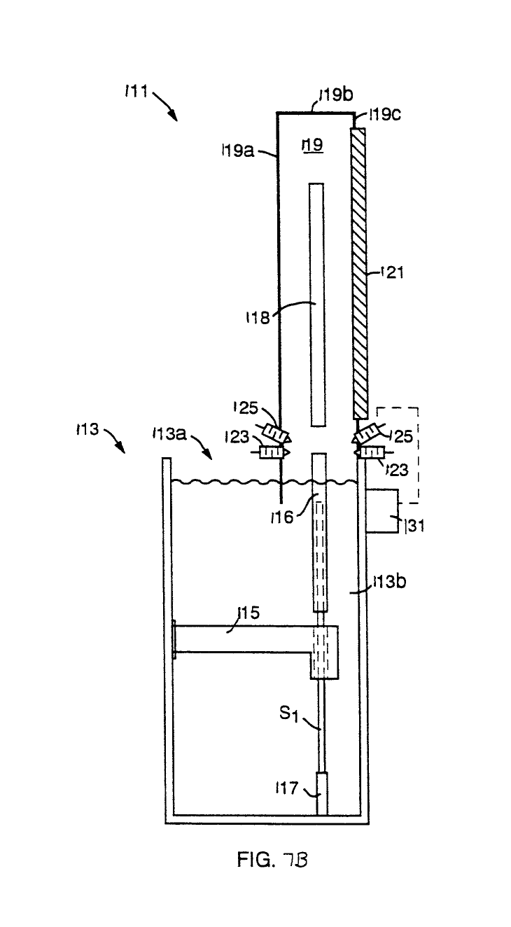

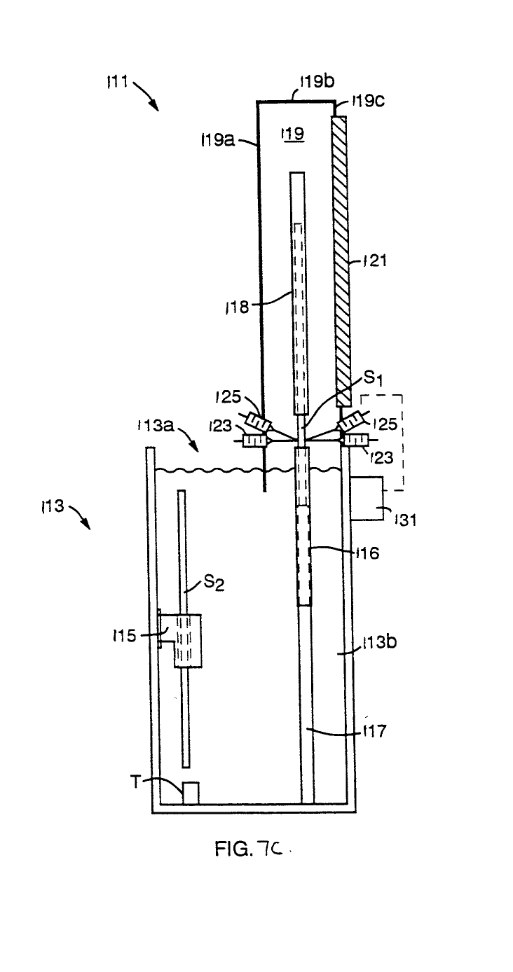

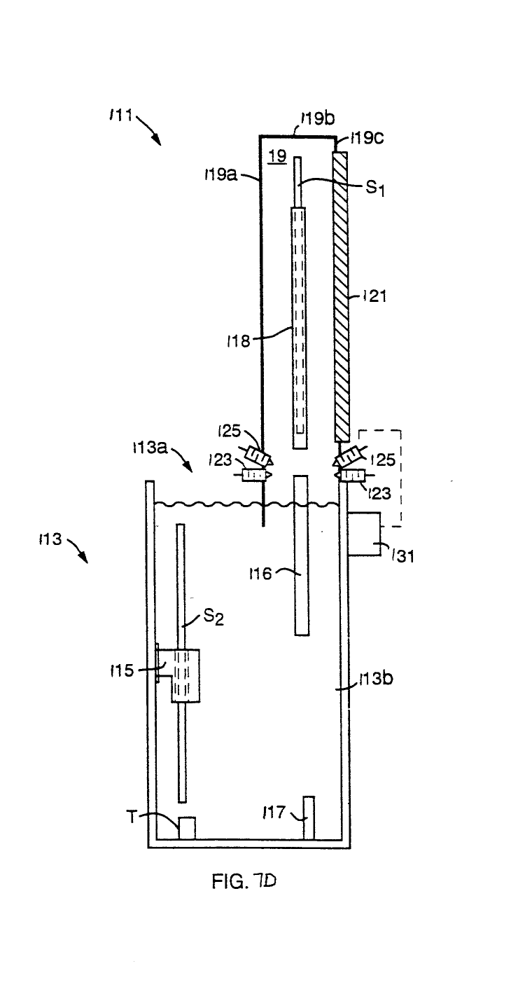

The rinsing fluid nozzles 123 and/or the drying vapor nozzles 125 are coupled to a controller 131, and the controller 131 is programmed to conserve rinsing fluid and/or drying vapor by selectively disengaging the outermost nozzles in the rinsing fluid and/or the drying vapor arrays while the lower half of the substrate S passes thereby. The controller 131 also may be coupled to the lifting mechanism 117, to the positioning pins 122a, 122b, and to the substrate shuttle 115 and is programmed to cause the same to operate as further described with reference to FIGS. 7A-D.

FIGS. 7A-D are sequential side elevational views of the exemplary cleaning/drying system 111 of FIGS. 6A and 6B, which are useful in describing the operation of the inventive cleaning/drying system 111. As shown in FIG. 7A, the substrate shuttle 115 is initially in a retracted position within the substrate receiving and cleaning portion 113a of the tank 113, and a substrate S is lowered into the substrate shuttle 115 via a wafer handler (not shown).

The substrate S is megasonically cleaned within the substrate receiving and cleaning portion 113a via megasonic energy emitted from one or more transducers T positioned within the substrate receiving and cleaning portion 113a. To facilitate even cleaning across the entire surface of the substrate S, the substrate S may be rotated via rollers (not shown). After the substrate S is clean, the substrate shuttle 115 extends, carrying the substrate S into the substrate rinsing portion 113b of the tank 113 as shown in FIG. 7B.

The lifting mechanism 117 elevates, contacting the lower edge of the substrate S and slowly lifting the substrate S from the fluid (FIG. 7C). The substrate S preferably is lifted at a speed less than or equal to the vertical velocity component of rinsing fluid flowing out of the tip of the meniscus M.

As the substrate S reaches the top of the tank fluid, the rinsing fluid nozzles 123 are engaged and begin to spray rinsing fluid such that the substrate S is contacted with rinsing fluid immediately as it is lifted from the bath and thus does not dry (e.g., via evaporation) prior to reaching the drying vapor nozzles 125. The flow rate of the rinsing fluid spray is controlled to prevent rinsing fluid from splashing into or above the drying vapor spray. As stated, to affect precise positioning of the rinsing fluid, one or more of the inventive spray bar assemblies 31a-31d of FIGS. 2-3C may be employed to deliver the rinsing fluid to the substrate S.

As soon as the substrate S intersects the rinsing fluid spray) from the rinsing fluid nozzles 123, the drying vapor nozzles 125 are engaged and direct a drying vapor flow to the rinsing fluid meniscus M which forms on the surface of the substrate S. As stated, to affect precise positioning of the drying vapors, one or more of the inventive spray bar assemblies 31a-31d of FIGS. 2-3c may be employed to deliver drying vapors to the substrate S. The drying vapors are absorbed by the rinsing fluid, which lowers the surface tension of the rinsing fluid and induces a Marangoni flow from the meniscus toward the bulk of the rinsing fluid. The Marangoni flow thereby dries the substrate's surface leaving the surface free of streaks, spotting and/or cleaning fluid residue.

As the lifting mechanism 117 lifts the substrate S into the drying enclosure 119, the first and second supporting sides 115a, 115b of the substrate shuttle 115 followed by the first pair of rails 116a, 116b provide stabilizing contact along the edges of the substrate S. After the substrate S disengages supporting sides 115a, 115b of the shuttle 115, the shuttle is returned to the receiving and cleaning portion 113a of the tank 113 and is ready to receive and clean the next substrate. The first pair of rails 116a, 116b support the substrate S below the air/substrate/rinsing fluid interface 127. The dry part of the substrate S is guided and supported by the second pair of rails 118a, 118b as the substrate S enters the drying enclosure 119. The gap between the first pair of rails 116a, 116b and the second pair of rails 118a, 118b is sufficient to accommodate the rinsing fluid nozzles 123 and the drying vapor nozzles 125, such that the substrate is dry when it encounters the second pair of rails 118a, 118b (e.g., 5-10 mm). The lifting mechanism 17 continues to lift the substrate S until the bottom portion thereof has passed through the drying meniscus M (FIG. 7C). When the substrate S is 3-5 mm above the positioning pins 122a, 122b, controller 131 releases the positioning pins 122a, 122b. The lifting mechanism 117 retracts, the substrate S lowers therewith until the substrate is supported by the positioning pins 122a, 122b, the rinsing fluid spray stops and residual rinsing fluid is driven off the substrate S's surface by the combined surface tension gradient and by a pulse of hot nitrogen which is applied to the bottom 3 mm of the substrate via a nozzle (not shown) for 1-2 seconds. Afterwards, the substrate S is unloaded from the drying enclosure 119 via the sealable port 121. The positioning pins 122a, 122b fix the Z-axis coordinate of the substrate S at a known position such that an unloading robot (not shown) may repeatably extract the substrate S.

As the substrate is rinsed and dried the rinsing fluid flows from the substrate into the tank 113, where it joins the tank fluid and overflows into overflow weirs (not shown). The rinsing fluid also could be continuously introduced from the bottom of the tank 113 and may be recirculated through a heater and filter.

As shown in FIG. 7D, during the time in which the substrate S is lifted into the first pair of rails 116a, 116b, the substrate shuttle 115 retracts into the substrate receiving and cleaning portion 113a and a second substrate S₂ is loaded into the substrate shuttle 115 via a wafer handler (not shown). Thereafter, the second substrate S₂ is megasonically cleaned while the first substrate S₁ is being rinsed and dried until the lifting mechanism 117 retracts. If cleaning and rinsing in the receiving and cleaning portion 113a is complete, substrate S₂ is ready to be shuttled to the substrate rinsing portion 113b, while the first substrate S₁ is unloaded from the drying enclosure 119 via the sealable port 121. In this manner the throughput of the inventive cleaning/drying system 111 is increased, as the load and unload time required of conventional tank systems overlaps with the time required for processing (cleaning, rinsing and drying). In at least one embodiment of the invention, the rinsing fluid is not employed and drying vapors are directed (e.g., via one or more of the inventive spray bar assemblies 31a-31d of FIGS. 2-3C) toward an air/substrate/cleaning fluid interface formed when a substrate is lifted from the cleaning fluid (e.g., via the lifting mechanism 117).

The foregoing description discloses only exemplary embodiments of the invention. Modifications of the above-disclosed apparatus and methods which fall within the scope of the invention will be readily apparent to those of ordinary skill in the art. For instance, the mounting devices described above for supporting the spray bar 33 are merely exemplary, and other mounting devices may be employed. Additionally, the fluid output from the nozzles 21 may have a circularly shaped pattern, an elliptically shaped pattern or any other pattern.

Accordingly, while the present invention has been disclosed in connection with exemplary embodiments thereof, it should be understood that other embodiments may fall within the spirit and scope of the invention, as defined by the following claims.

The invention claimed is:

1. An apparatus comprising:
a spray bar having an alignment mark and one or more openings, the spray bar configured to output a fluid spray from the one or more openings;
a mounting device having an alignment mark, the mounting device configured to support the spray bar; and
a substrate support configured to support a substrate;
wherein the alignment mark of the spray bar and the alignment mark of the mounting device may be aligned so as to position a fluid spray output by the spray bar toward a substrate supported by the substrate support.

2. The apparatus of claim 1 wherein the one or more openings comprise one or more nozzles.

3. The apparatus of claim 1 further comprising a scrubber brush configured to contact a surface of a substrate supported by the substrate support.

4. The apparatus of claim 1 wherein the alignment mark of the spray bar and the alignment mark of the mounting device comprise a pair of holes.

5. The apparatus of claim 1 wherein at least one of the alignment mark of the spray bar and the alignment mark of the mounting device comprises a notch.

6. The apparatus of claim 1 wherein the spray bar comprises a plurality of alignment marks.

7. The apparatus of claim 1 wherein the mounting device comprises a plurality of alignment marks.

8. A method comprising:
providing a spray bar having an alignment mark, the spray bar adapted to output a fluid spray;
providing a mounting device having an alignment mark, the mounting device adapted to support the spray bar; and
aligning the alignment mark of the spray bar and the alignment mark of the mounting device so as to position a fluid spray output by the spray bar toward a substrate supported by the substrate support.

9. A scrubber device comprising:
a spray bar having an alignment mark, the spray bar configured to output a fluid spray;
a mounting device having an alignment mark, the mounting device configured to support the spray bar;
a substrate support configured to support a substrate; and
at least one scrubber brush configured to contact a surface of a substrate supported by the substrate support;
wherein the alignment mark of the spray bar and the alignment mark of the mounting device may be aligned so as to position a fluid spray output by the spray bar toward the at least one scrubber brush.

10. The scrubber device of claim 9 wherein the one or more openings comprise one or more nozzles.

11. The scrubber device of claim 9 wherein the alignment mark of the spray bar and the alignment mark of the mounting device comprise a pair of holes.

12. The scrubber device of claim 9 wherein at least one of the alignment mark of the spray bar and the alignment mark of the mounting device comprises a notch.

13. The scrubber device of claim 9 wherein the spray bar comprises a plurality of alignment marks.

14. The scrubber device of claim 9 wherein the mounting device comprises a plurality of alignment marks.

15. A method comprising:
providing a spray bar having an alignment mark, the spray bar adapted to output a fluid spray;
providing a mounting device having an alignment mark, the mounting device adapted to support the spray bar;
providing at least one scrubber brush adapted to contact a surface of a substrate supported by the substrate support; and
aligning the alignment mark of the spray bar and the alignment mark of the mounting device so as to position a fluid spray output by the spray bar toward the at least one scrubber brush.

16. An apparatus configured to rinse and dry a substrate, comprising:
a tank of cleaning fluid configured to at least partially submerge a substrate;
a lifting mechanism configured to lift a substrate from the cleaning fluid; and
a drying vapor source positioned to supply drying vapors to an air/substrate/cleaning fluid interface formed when the lifting mechanism lifts a substrate from the cleaning fluid, the drying vapor source comprising:
a spray bar having an alignment mark and one or more openings, the spray bar configured to output a drying vapor from the one or more openings; and
a mounting device having an alignment mark, the mounting device configured to support the spray bar;
wherein the alignment mark of the spray bar and the alignment mark of the mounting device may be aligned so as to position a drying vapor output by the spray bar toward the air/substrate/cleaning fluid interface.

17. The apparatus of claim 16 wherein the one or more openings comprise one or more nozzles.

18. The apparatus of claim 16 wherein the alignment mark of the spray bar and the alignment mark of the mounting device comprise a pair of holes.

19. The apparatus of claim 16 wherein at least one of the alignment mark of the spray bar and the alignment mark of the mounting device comprises a notch.

20. The apparatus of claim 16 wherein the spray bar comprises a plurality of alignment marks.

21. The apparatus of claim 16 wherein the mounting device comprises a plurality of alignment marks.

22. A method for cleaning, rinsing and drying a substrate comprising:
at least partially submerging a substrate in a tank of cleaning fluid;
lifting the substrate from the cleaning fluid;
providing a spray bar having an alignment mark, the spray bar adapted to output a drying vapor;
providing a mounting device having an alignment mark, the mounting device adapted to support the spray bar; and
aligning the alignment mark of the spray bar and the alignment mark of the mounting device so as to position a drying vapor output by the spray bar toward an air/substrate/cleaning fluid interface formed when the first substrate is lifted from the cleaning fluid.

23. An apparatus configured to rinse and dry a substrate, comprising:
a tank of cleaning fluid configured to at least partially submerge a substrate;
a lifting mechanism configured to lift a substrate from the cleaning fluid;
a rinsing fluid source positioned to supply rinsing fluid to a surface of a substrate as the lifting mechanism lifts the substrate from the cleaning fluid, wherein the rinsing fluid contacts the substrate thereby forming an air/substrate/rinsing fluid interface; and
a drying vapor source positioned to supply drying vapors to the air/substrate/rinsing fluid interface, the drying vapor source comprising:
a spray bar having an alignment mark and one or more openings, the spray bar configured to output a drying vapor from the one or more openings; and
a mounting device having an alignment mark, the mounting device adapted to support the spray bar;
wherein the alignment mark of the spray bar and the alignment mark of the mounting device may be aligned so as to position a drying vapor output by the spray bar toward the air/substrate/rinsing fluid interface.

24. The apparatus of claim 23 wherein the one or more openings comprise one or more nozzles.

25. The apparatus of claim 23 wherein the alignment mark of the spray bar and the alignment mark of the mounting device comprise a pair of holes.

26. The apparatus of claim 24 wherein at least one of the alignment mark of the spray bar and the alignment mark of the mounting device comprises a notch.

27. The apparatus of claim 24 wherein the spray bar comprises a plurality of alignment marks.

28. The apparatus of claim 24 wherein the mounting device comprises a plurality of alignment marks.

29. A method for cleaning, rinsing and drying a substrate comprising:
at least partially submerging a substrate in a tank of cleaning fluid;
lifting the substrate from the cleaning fluid;
spraying rinsing fluid onto the surface of the substrate as the substrate is lifted, thereby forming an air/substrate/rinsing fluid interface;
providing a spray bar having an alignment mark, the spray bar adapted to output a drying vapor;
providing a mounting device having an alignment mark, the mounting device adapted to support the spray bar; and
aligning the alignment mark of the spray bar and the alignment mark of the mounting device so as to position a drying vapor output by the spray bar toward the air/substrate/rinsing fluid interface.

30. An apparatus configured to rinse and dry a substrate, comprising:
a tank of cleaning fluid configured to at least partially submerge a substrate;
a lifting mechanism coupled to the tank and configured to lift a substrate from the cleaning fluid;
a rinsing fluid source positioned to supply rinsing fluid to a surface of a substrate as the lifting mechanism lifts the substrate from the cleaning fluid, wherein the rinsing fluid contacts the substrate thereby forming an air/substrate/rinsing fluid interface, wherein the rinsing fluid source comprises:
a spray bar having an alignment mark and one or more openings, the spray bar configured to output rinsing fluid from the one or more openings; and
a mounting device having an alignment mark, the mounting device configured to support the spray bar;
wherein the alignment mark of the spray bar and the alignment mark of the mounting device may be aligned so as to position rinsing fluid output by the spray bar toward an air/substrate interface thereby forming the air/substrate/rinsing fluid interface; and
a drying vapor source positioned to supply a drying vapor to the air/substrate/rinsing fluid interface.

31. A method for cleaning, rinsing and drying a substrate comprising:
at least partially submerging a substrate in a tank of cleaning fluid;
lifting the substrate from the cleaning fluid;
providing a spray bar having an alignment mark, the spray bar adapted to output rinsing fluid;
providing a mounting device having an alignment mark, the mounting device adapted to support the spray bar;
aligning the alignment mark of the spray bar and the alignment mark of the mounting device so as to position rinsing fluid output by the spray bar toward the substrate thereby forming an air/substrate/rinsing fluid interface; and
supplying a drying vapor to the air/substrate/rinsing fluid interface.
